(19) United States
(12) Patent Application Publication
(10) Pub. No.: US 2019/0297532 A1
(43) Pub. Date: Sep. 26, 2019

(54) Application Notifications From Network For Throughput And Flow Control Adaptation

(71) Applicant: Nokia Technologies Oy, Espoo (FI)

(72) Inventors: Jonathan Ling, North Brunswick, NJ (US); Bongho Kim, Morganville, NJ (US)

(73) Assignee: Nokia Technologies Oy

(21) Appl. No.: 15/926,273

(22) Filed: Mar. 20, 2018

(51) Int. Cl. H04W 28/10; H04W 28/02; H04W 24/02

(52) U.S. Cl. CPC H04W 28/10; H04W 28/0226; H04L 5/0055; H04W 24/02; H04W 28/0205

(57) ABSTRACT

A method is provided including: inserting at least one link layer request message into a data stream to be transmitted by the apparatus, where the data stream corresponds to an application and comprises a plurality of data parts, and where the at least one link layer request message requests a status of a transmission of a first data part of the plurality of data parts from a first communication protocol of the apparatus; receiving a link layer response message indicative of the status of the transmission of the first data part from the first communication protocol; and controlling a flow of the data stream based on the link layer response message.

### TECHNICAL FIELD

Various example embodiments relate generally to wireless networks and, more specifically, relate to throughput and flow control adaptation in wireless networks.

### BACKGROUND

Wireless networks must be designed to meet the growing demands of applications. Future wireless networks will need to support applications having specific QoS requirements, such as high-bit rates and low latencies for example, thus presenting the wireless networks with multiple QoS flows. For example, applications may present the network with multiple audio/video streams and real-time information from tactical sensors, for example. These wireless QoS requirements are difficult to achieve due to a number of reasons, including radio impairments, fading, multipath, shadowing, interference, measurement gaps, varying load, thermal conditions, processing power, and proportional sharing.

Abbreviations that may be found in the specification and/or the drawing figures are defined below, after the main part of the detailed description section.

### BRIEF SUMMARY

This section is intended to include examples and is not intended to be limiting.

According to an example of an embodiment, a method is provided, the method including: inserting at least one link layer request message into a data stream to be transmitted by the apparatus, wherein the data stream corresponds to an application and comprises a plurality of data parts, and wherein the at least one link layer request message requests a status of a transmission of a first data part of the plurality of data parts from a first communication protocol of an apparatus; receiving a link layer response message indicative of the status of the transmission of the first data part from the first communication protocol; and controlling a flow of the data stream based on the link layer response message.

According to another example of an embodiment, an apparatus is provided comprising means for performing: inserting at least one link layer request message into a data stream to be transmitted by the apparatus, wherein the data stream corresponds to an application and comprises a plurality of data parts, and wherein the at least one link layer request message requests a status of a transmission of a first data part of the plurality of data parts from a first communication protocol of the apparatus; receiving a link layer response message indicative of the status of the transmission of the first data part from the first communication protocol; and controlling a flow of the data stream based on the link layer response message.

According to another example of an embodiment, a computer readable medium comprising program instructions is provided. The program instructions may cause the apparatus to perform at least the following: inserting at least one link layer request message into a data stream to be transmitted by an apparatus, wherein the data stream corresponds to an application and comprises a plurality of data parts, and wherein the at least one link layer request message requests a status of a transmission of a first data part of the plurality of data parts from a first communication protocol of the apparatus; receiving a link layer response message indicative of the status of the transmission of the first data part from the first communication protocol; and controlling a flow of the data stream based on the link layer response message.

### BRIEF DESCRIPTION OF THE DRAWINGS

Some example embodiments will now be described with reference to the accompanying drawings.

FIG. 1 is a block diagram of one possible and non-limiting exemplary system in which exemplary embodiments may be practiced;

FIG. 2 shows an example embodiment of the subject matter described herein;

FIG. 3 is a simplified block diagram showing the data flow between different protocol layers;

FIGS. 4A and 4B shows PDCP and RLC protocol layers with enhanced messaging in accordance with an example embodiment of the subject matter described herein;

FIG. 5 is a control message in accordance with an example embodiment of the subject matter described herein;

FIG. 6 shows a simulated video transmission network in accordance with an example embodiment of the subject matter described herein;

FIG. 7 shows results for observed video frame transmission rate and actual receive rates from the simulation from a simulation in accordance with an example embodiment of the subject matter described herein; and

FIG. 8 is a logic flow diagram for application notifications from a network for throughput and flow control adaptation, and illustrates the operation of exemplary methods, a result of execution of computer program instructions embodied on a computer readable memory, functions performed by logic implemented in hardware, and/or interconnected means for performing functions in accordance with exemplary embodiments.

### DETAILED DESCRIPTION

The exemplary embodiments herein describe techniques for application notifications from network for throughput and flow control adaptation. Additional description of these techniques is presented after a system into which the exemplary embodiments may be used is described.

Features as described herein generally refer to LTE terms, however, it should be noted that these features may be used in the future with other types of systems. For example, references to an eNB (i.e. an LTE base station) are equally applicable to future base stations of wireless networks (such as, for example, base stations in 5G wireless networks referred to as gNB) unless indicated otherwise.

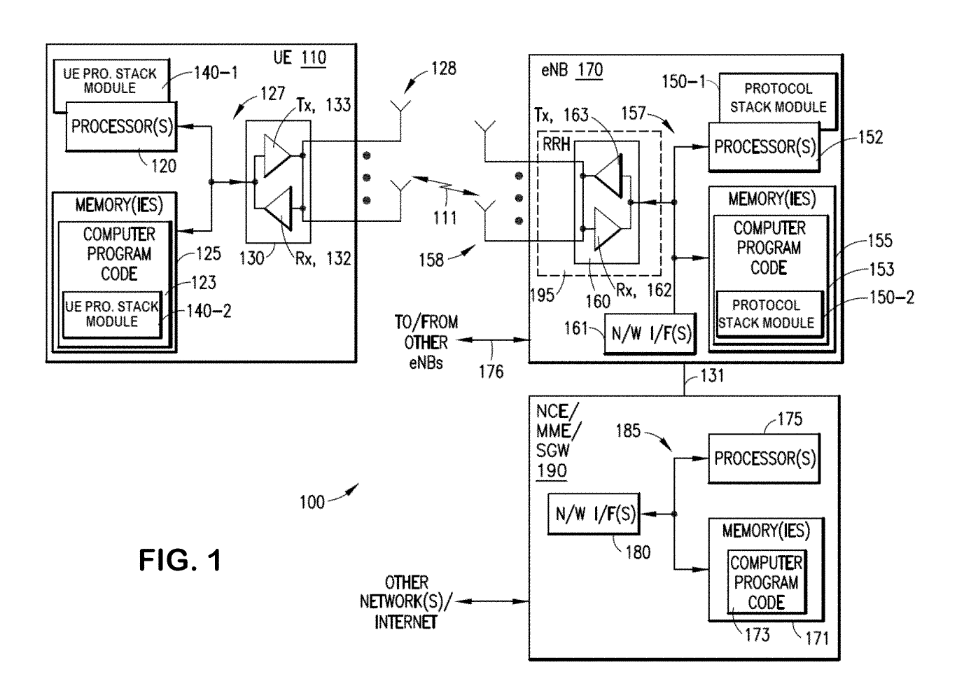

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a UE protocol stack module, comprising one of or both parts 140-1 and/or 140-2, which may be implemented in a number of ways. The UE protocol stack module may be implemented in hardware as UE protocol stack module 140-1, such as being implemented as part of the one or more processors 120. The UE protocol stack module 140-1 may be implemented also as an integrated circuit or through other hardware such as a programmable gate array. In another example, the UE protocol stack module 140 may be implemented as UE protocol stack module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The eNB (evolved NodeB) 170 is a base station (e.g., for LTE, long term evolution) that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a protocol stack module, comprising one of or both parts 150-1 and/or 150-2, which may be implemented in a number of ways. The protocol stack module may be implemented in hardware as protocol stack module 150-1, such as being implemented as part of the one or more processors 152. The protocol stack module 150-1 may be implemented also as an integrated circuit or through other hardware such as a programmable gate array. In another example, the protocol stack module may be implemented as protocol stack module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

It is noted that description herein indicates that “cells” perform functions, but it should be clear that the eNB that forms the cell will perform the functions. The cell makes up part of an eNB. That is, there can be multiple cells per eNB. The term “cell” may refer to the coverage area of a given set of transceivers associated with a eNB, or may refer to the logical part of the eNB that performs functions related to the transmission/reception within that coverage area. For instance, there could be three cells for a single eNB carrier frequency and associated bandwidth, each cell covering one-third of a 360 degree area so that the single eNB's coverage area covers an approximate oval or circle. Furthermore, each cell can correspond to a single carrier and an eNB may use multiple carriers. So if there are three 120 degree cells per carrier and two carriers, then the eNB has a total of 6 cells.

The wireless network 100 may include one or more network control elements (NCE) 190 that may include MME (Mobility Management Entity) and/or SGW (Serving Gateway) functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, eNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the various exemplary embodiments, the exemplary embodiments will now be described with greater specificity.

In order to meet wireless QoS requirements, some real-time applications dynamically adapt themselves to network delay and bandwidth. Ideally applications would instantaneously adapt themselves; however, such adjustments are based on end to end measurements and thus take at least one round-trip-time (RTT) to adjust, and typically more than one RTT to smooth the responses. Thus, RTT adversely affects the quality of the adaptation. For example, in rate adaptation of real-time video (such as video conferencing) a video receiver may send back an estimate of the achievable rate end to end. Also, if there is congestion then the video receiver may send back a notification so that the sender will transmit dummy frames until the congestion event is over. For example, if the channel rate drops, the transmitter will not find this out until at least one RTT. Before receiving feedback (i.e. before one RTT), the transmitter may continue to send at a higher rate. If the radio link is the bottleneck, then packets will be buffered at the sender, and be transmitted at the link rate which is lower than the traffic input rate, and delivered late.

The approximate outage period of, for example in real-time video, may be calculated as follows:
1. Assume a video stream rate Rᵥ₁, where a channel bandwidth R₁ drops so that R_{2<}R_{V1};
2. A receiver obtains delayed frame at RTT/2+TX_delay (i.e. the wired+wireless delay) and deduces a new rate send the new rate back to the sender;
3. The new rate arrives at RTT+TX_delay at sender, but there are N=(RTT+TX_delay))/T_{f} total frames of video that need to be flushed first;
4. Wait for all video frames at old rate to clear buffer, then send new rate.

The outage period for the above is approximately equal to:

$$\frac{{R}_{v 1}}{{R}_{2}} ( RTT + {T}_{f} \frac{{R}_{v 1}}{{R}_{2}} ) .$$

This can be described even more simply as RTT*K, where K is

$$\frac{{R}_{v 1}}{{R}_{2}} .$$

Some attempts to address these problems include using multiple radio bearer support and using intra-flow priority queue. However, each one of these attempts suffers from one or more of the following disadvantages: the network operator is required to allocate more resources, for example an additional GBR bearer, which reduces the resources of other users in the case multiple radio bearer support; intra-flow priority queues are overly complex, require classification and identification of traffic, and/or require a dynamic application-network interface.

Various example embodiments described herein recognize that a modem (such as an LTE modem for example) is often times the bottleneck when the modem is included in the path between the application and the server, and provide a general flow-control mechanism to assist the application in detecting and adapting to rate drops. In some examples, this flow-control mechanism relates to how communications are transmitted to the MAC layer, and up, to provide the application with a local throughput and congestion event notification.

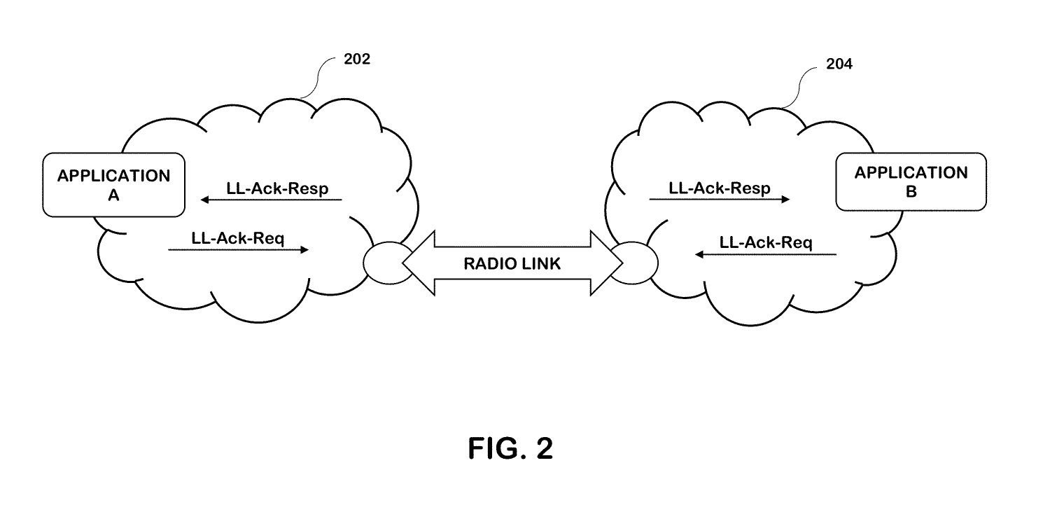

Referring now to FIG. 2, this figure is a simplified diagram showing messages exchanged between two applications in accordance with an example embodiment. In particular, FIG. 2 includes an Application A that sends messages to Application B over a radio link and requests link layer acknowledgments, and vice versa. In this example, a transport layer protocol, or the application itself, may insert Link Layer (LL) Ack-Req messages within its user datagram protocol (UDP) packet stream. The request and response messages may be IP packets, which are trapped at the PDCP layer, and not sent over-the-air. For example, before and after every video frame, an LL-Ack-Req may be sent, and a link layer response is generated indicating transmission by the modem, and delivered to the application, which keeps track of the responses.

According to example embodiments the link layer response may be generated based on at least one of the following three events:
(i) when the RLC is notified of transmission opportunity and it fits;
(ii) when the HARQ process produces a final response ACK or NACK; and
(iii) when in AM the status PDU is received with ACK or NACK.

For option (i), the timestamp ignores the over-the-air transmission delay, but is relatively easy to implement. For option (ii), additional communications between layers is required to obtain the HARQ process feedback, but this option also provides better indication of delivery as well as delay. Option (iii) provides the most accurate indication of delivery, but there is delay in receiving the RLC Status PDU, as the ACK/NACKs are aggregated and then delivered over-the-air.

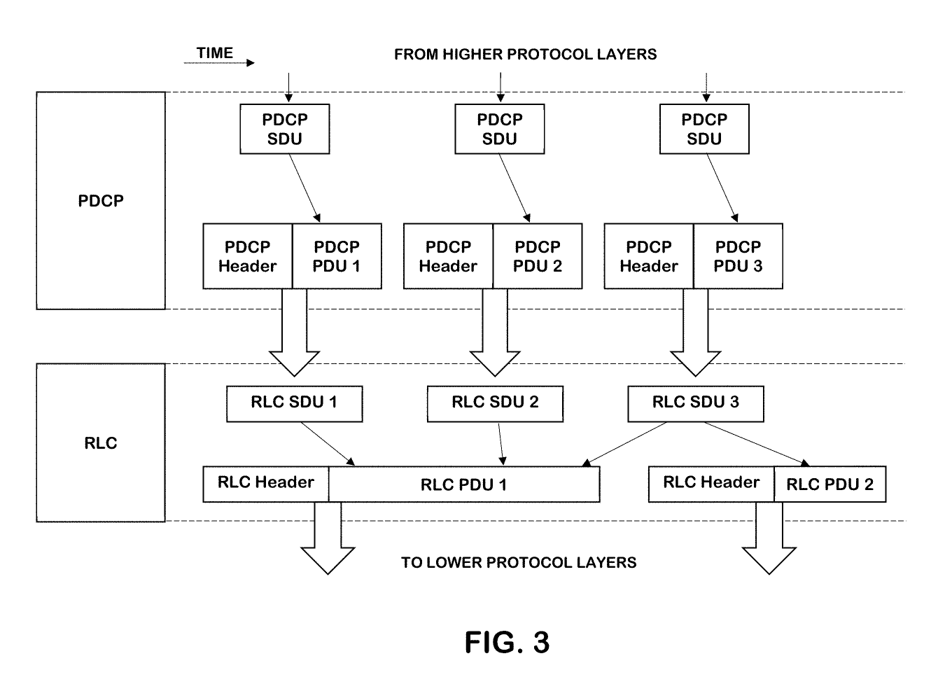

FIG. 3 is a simplified block diagram a simplified block diagram showing the data flow between different protocol layers of a transmitting entity. In particular, the example shown in FIG. 3 shows packets (e.g. IP packets) received at the PDCP layer corresponding to PDCP service data units (SDUs). The PDCP layer generates PDCP PDUs from the PDCP SDUs and adds a PDCP header. These packets are then sent to the RLC layer. The RLC layer receives the packets (RLC SDUs) from the PDCP layer. The RLC layer processes the packets to form RLC PDUs which are then passed down the protocol stack and eventually transmitted by the transmitting entity. In this example, the RLC layer concatenates the RLC SDU 1 and RLC SDU 2 and segments RLC SDU 3. As such, RLC PDU 1 is associated with RLC SDU 1, RLC SDU 2, and part of RLC SDU 3. RLC PDU 3 is associated with the remaining part of RLC SDU 3.

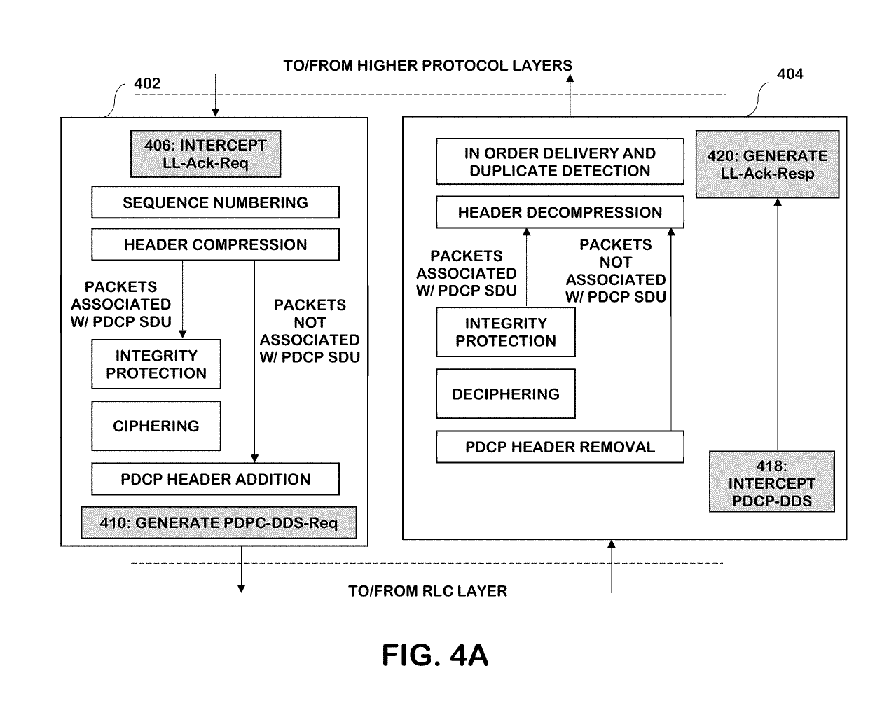

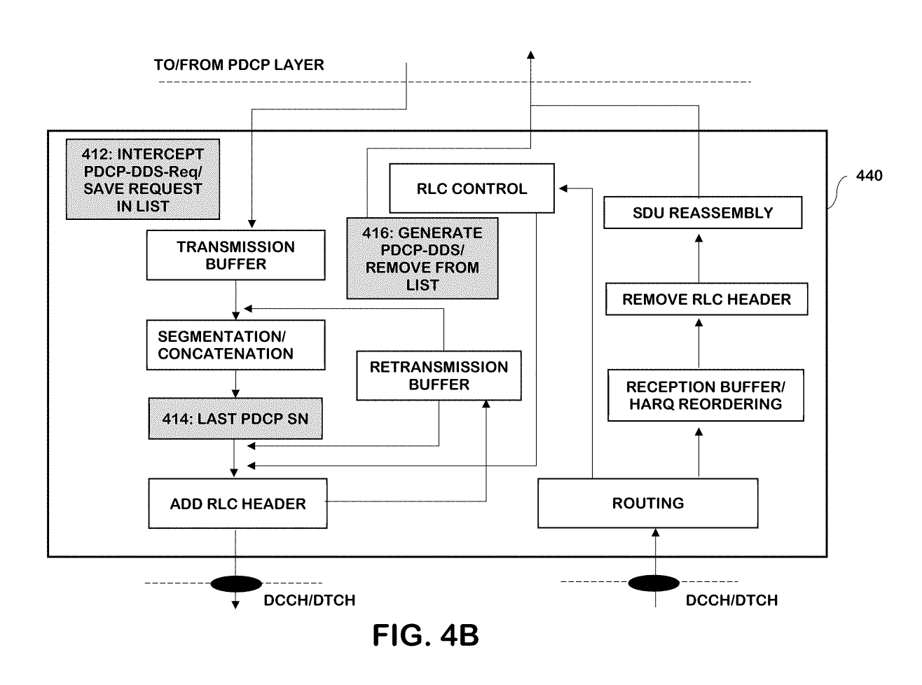

FIGS. 4A and 4B are block diagrams showing enhanced cross protocol messaging scheme implemented in the PDCP and RLC layers, respectively, in accordance with some example embodiments. It is noted that according to some example embodiments, the network may initially configure a UE to support cross protocol layer communication (such as for ‘application layer acknowledgements’ for example). The configuration may include a request message type and a valid source IP address of such requests. In FIGS. 4A and 4B, the enhanced messaging scheme is shown in the darker shaded blocks while other functionalities of the PDCP and RLC layers are shown in the remaining blocks. The enhanced messaging procedure shown in FIGS. 4A and 4B includes the following:
1. An application or an agent (such as some other entity for example) may send a control message requesting a link layer acknowledgement after a certain amount of data is sent from the application or agent. This request for the link layer acknowledgement (i.e. LL-Ack-Req) may be transmitted to the PDCP entity 402 as shown in FIG. 4A. The request may also be accomplished such as by sending an IP packet with a specific option field or by using a new ICMP packet to request a link layer acknowledgment for example. It is noted that these request and response packets are referred to generically herein using the terms LL-Ack-Req and LL-Ack-Resp.
2. At 406, the LL-ACK-Req is intercepted by the PDCP layer. The PDCP layer records a source address (Ack-Req-SA), a request sequence number (Ack-Req-SN), a PDCP sequence number (Ack-Req-PDCP-SN) of the previous data packet, and the current time. The LL-Ack-Req packet is then discarded by the PDCP layer of the transmitting entity 402.
3. Next, the transmitting PDCP entity 402 generates sends down to the RLC layer 340, a data delivery status (DDS) request (PDCP-DDS-Req) message that has the PDCP-DDS-SN equal to the Ack-Req-PDCP-SN as indicated by 410.
4. At 412, the RLC layer 440 intercepts the PDCP-DDS-Req. In both unacknowledged mode (UM) and acknowledged mode (AM), after the transmission opportunity and after the RLC segments the RLC SDUs, if Ack-Req-PDCP-SN is in the range of transmitted SDUs then a “DDS-Resp” is generated with the data/control (D/C) bit set to control as indicated by 416. The RLC-DDS-Resp includes the SN of the PDCP-DDS-Req. For example, a list may be implemented in the RLC layer that includes the sequence numbers for which delivery notifications have been requested. At 414, the last SDU SN that is put into the transmission opportunity (which could be either a segment or a whole packet) is obtained and compared to the sequence numbers in the list. If so, then the DDS-Resp is generated as described above.
5. The egress PDCP entity 404, receives the DDS-Resp message at block 418, and generates an LL-Ack-Resp packet. The LL-ACK-Resp packet comprises: a destination address equal to the Ack-Req-SA, the Ack-Req-SN, a status, a timestamp in, and a timestamp out. This LL-ACK-Resp packet is then sent up the protocol stack to the application as shown in block 420. The status in the LL-ACK-Resp is set to one of ACK, NACK, or NULL, where NULL is used to indicate that the UE lost track of the request and cannot give a response. For example, LL-ACK-Resp may be set to NULL when an error occurs, when the internal state is flushed and/or when the internal state is confused (such as when the UE temporarily loses connection with the network for example). In downlink the error may be, for example, when there is a handoff and the base station is being changed, and in uplink the error may be, for example when too many LL-ACK-Reqs are requested. Accordingly, if a DDS-Resp is not eventually obtained, there will be a timeout, the DDR-Req will be flushed, and the LL-Ack-Resp NULL generated.
6. The application may use the LL-Ack-Resp message from the PDCP layer to control the flow of the data, namely, the application may send a next data frame if a response is received or skip the next data frame if a response is not received. The large initial delay from the SR and BSR can be eliminated when estimating transmission delay by using the time difference between the LL-Ack-Resp from the start of the data frame and the LL-Ack-Resp from the end of the data frame. The estimated throughput may correspond to the number of bytes per travel time which can be lowered by the sender if the estimated delay is too high.

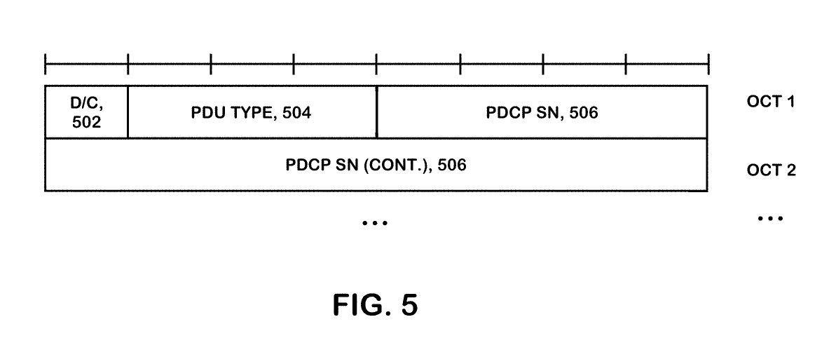

Referring now to FIG. 5 this figure shows a non-limiting example of a control message for requesting a link layer acknowledgement in accordance with some example embodiments. In this example, the control message format 500 includes a data/control field 502, a PDU type field 504, and a PDCP sequence number field 506. In this example, the PDCP SN field 506 is 12-bits long and the PDU type field 504 is 3-bits long. The PDU type field 504 may be configured with a value to indicate that the control message corresponds to a DDS request and/or response. The value indicated in the control message may be defined by a wireless standard, and may correspond to the following table for example (where A, B, C, etc. are different 3-bit values):

| Bit | Description |
|---|---|
| A | PDCP status report |
| B | Interspersed ROHC feedback packet |
| C | DDS Resp./Req. |
| . . . | Reserved |

It should be understood that the control message format 500 and the corresponding values are merely example, and other formats and/or values are also possible, such as control format messages with different lengths, different size fields, different values, and/or the like.

According to some example embodiments, an initial setup and/or configuration is performed so that the application knows certain information, such as an IP address and a UDP port of where to send the requests (e.g. LL-Ack-Req). For example, such information could be preconfigured in a user equipment and/or the information could be accessed on the internet if the application knows which cellular operator the user equipment is using. Another possibility is using a discovery protocol to discover such information. It is also noted that user equipments may be configured by the network (such as an MME for example) on a per user basis from the MME, in which case the UE and/or eNB would be configured to accept requests as described above (e.g. LL-Ack-Req), and the rate of such requests. Alternatively, a dynamic service is also possible where a wireless network (such as a 5G wireless network) may use an exposure function (NEF) to interface to the application, so that application can request this feature.

Although some of the example embodiments above describe a user equipment sending the requests and receiving the responses, this need not be the case. For example, in one example embodiment the requests (e.g. LL-Ack-Req) may be trapped and the responses (e.g. LL-ACK-Resp) may be generated by the network. In such examples, the process is completely network driven and the responses may be trapped at either the PDCP layer or IP layer at a network node (e.g. an eNB or PGW). It is noted in these network-driven examples, the LL-Ack-Resp would be sent over the air (downlink).

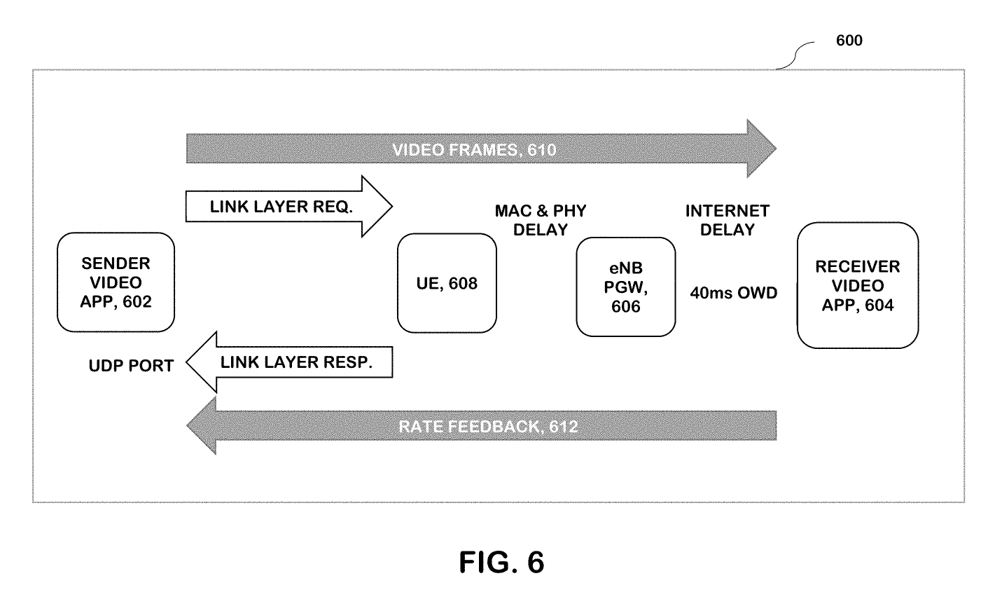

Referring now to FIG. 6, this figure shows an example of a video transmission network 600 that was used to simulate an enhanced messaging scheme in accordance with an example embodiment. In particular, the network 600 was simulated such that the enhanced messaging functionality was implemented at the PDCP and RLC layers in the LTE stack using a video sender application 602 for a user equipment 608, and a video receiver application 604 were designed to use and test the effectiveness using throughput and congestion event notifications in accordance with some example embodiments. The data was packetized (UDP) with RTP headers using the fed back rate 612 from the receiver frames (dummy data). In the example simulation, uplink video traffic transmission was used comprising video frames 610. A timestamp was added at the eNB 606 to allow the receiver to determine the transmission rate using the timestamp on the first and last packet of the frame.

The rate and congestion algorithms that were used in the simulation were as follows:

End-to-End, Video Source to Video Sink:
RTT estimation is used to set playback delay (Pbdelay), where Pbdelay=OWD+1.5 Frame Interval
Throughput estimation: Delay measurement of first packet and last packet of a frame using IP timestamping at eNB.
Congestion Detection: Two sequential late frames triggers congestion notification (CN) flag in frame rate response. If CN is received then sender generates dummy video frames until CN flag is cleared.

LL-Ack Feedback:
Throughput estimation: Link Layer Ack Requests sandwich the video frame. On reception of Link Layer Ack Requests, the time delay difference is used for throughput estimation.
Congestion Detection: If Link Layer Ack Response from n−1 is not received, then data frame is skipped.

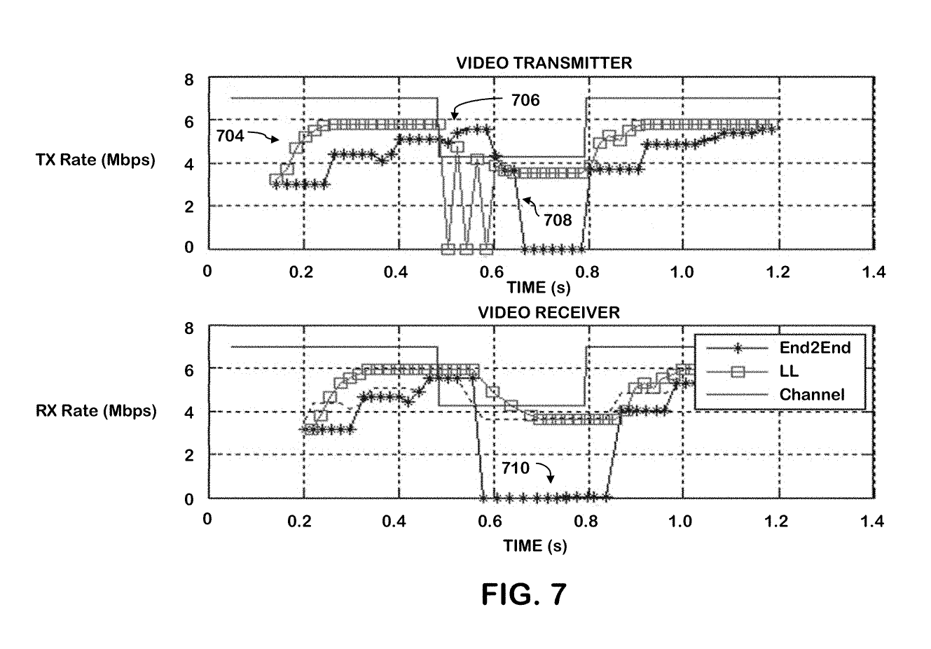

Referring also to FIG. 7, this figure shows the observed video frame transmission rate and actual receive rates according to a simulation for network 600 for both end-to-end feedback and link-layer feedback. The frame rate for the simulation is 50 frames per second. The frame rate is set to zero at the transmitter if congestion control is active in skipping or transmitting dummy frames. The rate is set to zero at the receiver if a frame misses its playback time. At 704, both the link layer acknowledgments method and the end-to-end technique experience a ramp-up period. In the simulation, the channel bandwidth dips from 7 to 4.1 Mbps momentarily (for example due to congestion) which occurs at approximately 0.5-0.8 s. FIG. 7 shows that the transmitter using link layer acknowledgments adjusts more quickly to the change in channel BW and handles the congestion more effectively. Namely, congestion control causes frames to be skipped as represented by 706 and 708 for the LL-Acknowledgments method and the end-to-end method, respectively. Using the LL-Acknowledgments method, the average sending rate was 5.1 Mbps during the example simulation, with 2 frames (4%) skipped, and no frames were dropped. In comparison, using the typical end-to-end feedback mechanism without LL-Acknowledgments, the average sending rate was 4.7 Mbps, with 7 frames (13%) skipped by the transmitter, and 15 frames (30%) dropped at the receiver as shown at 710 in FIG. 7. The outage with the end-to-end feedback method was 250 ms. The receiver side frame receive rate diagram clearly indicates that the end-to-end mechanism without LL-Acknowledgments experienced longer frame loss. In contrast, using LL-Acknowledgments no frame loss was experienced except the reduced receiving frame rate caused by the reduced air link rate (as shown in the ‘channel’ line of FIG. 7).

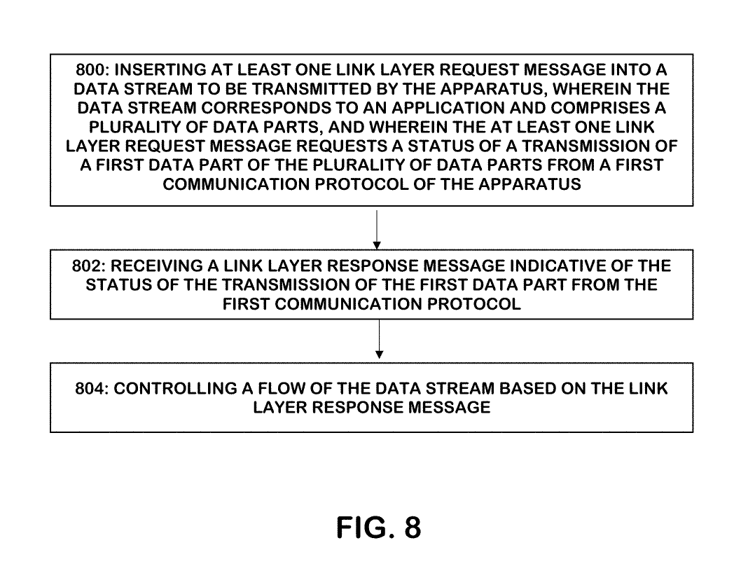

FIG. 8 is a logic flow diagram for application notifications from network for throughput and flow control adaptation. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the UE protocol stack module 140-1 and/or 140-2 or the protocol stack module 150-1 and/or 150-2 may include multiples ones of the blocks in FIG. 8, where each included block is an interconnected means for performing the function in the block. The blocks in FIG. 8 are assumed to be performed by a transmitting entity (such as the UE 110, e.g., under control of the UE protocol stack module 140-1 and/or 140-2 at least in part, or the eNB 170, e.g., under the control of the protocol stack module 150-1 and/or 150-2 at least in part).

According to an example of an embodiment, a method is provided, the method including: inserting at least one link layer request message into a data stream to be transmitted by an apparatus, wherein the data stream corresponds to an application and comprises a plurality of data parts, and wherein the at least one link layer request message requests a status of a transmission of a first data part of the plurality of data parts from a first communication protocol of the apparatus as indicated by block 800; receiving a link layer response message indicative of the status of the transmission of the first data part from the first communication protocol as indicated by block 802; and controlling a flow of the data stream based on the link layer response message as indicated by block 804.

The layer response message may include one of: a first value acknowledging the first data part has been transmitted by a modem of the apparatus; and a second value indicating the first data part was not transmitted and/or that the status of the transmission cannot be provided. Controlling the flow of the data stream may include: causing a next data part of the data stream be transmitted when the link layer response message acknowledges the transmission of the first data part, and causing the next part of the data stream to be skipped when the link layer response message fails to acknowledge transmission of the first data part of the application. The method may include: estimating a transmission delay of the data stream based on a first time value associated with the link layer response message wherein the link layer response message indicates that the first data part has been transmitted, and a second time value associated with a further link layer response message wherein the further link layer response message indicates that a next part of the data stream has been transmitted. The method may include: adjusting a transmission rate of the data stream based at least on the estimated transmission delay. The received link layer response message may be generated in response to determining by a second communication protocol of the apparatus a transmission opportunity for the first data part. The first communication protocol may be a packet data convergence protocol, and the second communication protocol may be a radio link control protocol. The at least one link layer request message and the received link layer response message may not be transmitted by the modem of the apparatus. The data stream may include a video stream such that each of the plurality of data parts of the data stream comprises a video frame. The video stream may be a real-time video stream. Inserting the at least one link layer request message may include: inserting a first link layer request message prior to each video frame in the data stream and a second link layer request message after each video frame in the data stream.

According to another example of an embodiment, an apparatus is provided comprising means for performing: inserting at least one link layer request message into a data stream to be transmitted by the apparatus, wherein the data stream corresponds to an application and comprises a plurality of data parts, and wherein the at least one link layer request message requests a status of a transmission of a first data part of the plurality of data parts from a first communication protocol of the apparatus; receiving a link layer response message indicative of the status of the transmission of the first data part from the first communication protocol; and controlling a flow of the data stream based on the link layer response message.

The layer response message may include one of: a first value acknowledging the first data part has been transmitted by a modem of the apparatus; and a second value indicating the first data part was not transmitted and/or that the status of the transmission cannot be provided. Controlling the flow of the data stream may include: causing a next data part of the data stream be transmitted when the link layer response message acknowledges the transmission of the first data part, and causing the next part of the data stream to be skipped when the link layer response message fails to acknowledge transmission of the first data part of the application. The means may be further configured to perform: estimating a transmission delay of the data stream based on a first time value associated with the link layer response message wherein the link layer response message indicates that the first data part has been transmitted, and a second time value associated with a further link layer response message wherein the further link layer response message indicates that a next part of the data stream has been transmitted. The means may be further configured to perform: adjusting a transmission rate of the data stream based at least on the estimated transmission delay. The received link layer response message may be generated in response to determining by a second communication protocol of the apparatus a transmission opportunity for the first data part. The first communication protocol may be a packet data convergence protocol, and the second communication protocol may be a radio link control protocol. The at least one link layer request message and the received link layer response message may not be transmitted by the modem of the apparatus. The data stream may include a video stream such that each of the plurality of data parts of the data stream comprises a video frame. The video stream may be a real-time video stream. Inserting the at least one link layer request message may include: inserting a first link layer request message prior to each video frame in the data stream and a second link layer request message after each video frame in the data stream. The means may include: at least one processor; and at least one memory including computer program code, the at least one memory and computer program code configured to, with the at least one processor, cause the performance of the apparatus.

According to another example of an embodiment, a computer readable medium may include program instructions for causing an apparatus to perform at least the following: inserting at least one link layer request message into a data stream to be transmitted by an apparatus, wherein the data stream corresponds to an application and comprises a plurality of data parts, and wherein the at least one link layer request message requests a status of a transmission of a first data part of the plurality of data parts from a first communication protocol of the apparatus; receiving a link layer response message indicative of the status of the transmission of the first data part from the first communication protocol; and controlling a flow of the data stream based on the link layer response message.

The layer response message may include one of: a first value acknowledging the first data part has been transmitted by a modem of the apparatus; and a second value indicating the first data part was not transmitted and/or that the status of the transmission cannot be provided. Controlling the flow of the data stream may include: causing a next data part of the data stream be transmitted when the link layer response message acknowledges the transmission of the first data part, and causing the next part of the data stream to be skipped when the link layer response message fails to acknowledge transmission of the first data part of the application. The program instructions may include: estimating a transmission delay of the data stream based on a first time value associated with the link layer response message wherein the link layer response message indicates that the first data part has been transmitted, and a second time value associated with a further link layer response message wherein the further link layer response message indicates that a next part of the data stream has been transmitted. The program instructions may include: adjusting a transmission rate of the data stream based at least on the estimated transmission delay. The received link layer response message may be generated in response to determining by a second communication protocol of the apparatus a transmission opportunity for the first data part. The first communication protocol may be a packet data convergence protocol, and the second communication protocol may be a radio link control protocol. The at least one link layer request message and the received link layer response message may not be transmitted by the modem of the apparatus. The data stream may include a video stream such that each of the plurality of data parts of the data stream comprises a video frame. The video stream may be a real-time video stream. Inserting the at least one link layer request message may include: inserting a first link layer request message prior to each video frame in the data stream and a second link layer request message after each video frame in the data stream.

Without in any way limiting the scope, interpretation, or application of the claims appearing below, a technical effect of one or more of the example embodiments disclosed herein is improving adaptation, namely, recovery from rate drop, on a non-GBR bearer. Another technical effect of one or more of the example embodiments disclosed herein is that it does not require classification/identification and thus there is no requirement to have a dynamic application-network interface. Another technical effect of one or more of the example embodiments disclosed herein is allowing a codec to tailor its adaptation strategy with knowledge of exactly which frame was transmitted.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
AM acknowledged mode
BSR buffer status report
DDS data delivery status
eNB (or eNodeB) evolved Node B (e.g., an LTE base station)
GBR guaranteed bit rate
I/F interface
ICMP internet control message protocol
LL link layer
LTE long term evolution
MAC media access control
MME mobility management entity
N/W network
NCE network control element
PDCP packet data convergence protocol
PDU packet data unit
QoS quality of service
RLC radio link control
RRH remote radio head
RTT round trip time
Rx receiver
SDU service data unit
SGW serving gateway
SN sequence number
SR scheduling request
TFT traffic filter template
Tx transmitter
UDP user datagram protocol
UE user equipment (e.g., a wireless, typically mobile device)
UM unacknowledged mode

1. An apparatus comprising:
at least one processor; and
at least one non-transitory memory including computer program code, the at least one memory and computer program code configured to, with the at least one processor, cause the apparatus to perform at least:
inserting at least one link layer request message into a data stream to be transmitted by the apparatus, wherein the data stream corresponds to an application and comprises a plurality of data parts, and wherein the at least one link layer request message requests a status of a transmission of a first data part of the plurality of data parts from a first communication protocol of the apparatus;
receiving a link layer response message indicative of the status of the transmission of the first data part from the first communication protocol; and
controlling a flow of the data stream based on the link layer response message, wherein the controlling of the flow of the data stream comprises selecting among 1) causing a next data part of the data stream to be transmitted or causing the next data part of the data stream to be skipped, and/or 2) adjusting a transmission rate of the data stream.

2. The apparatus as in claim 1, wherein the link layer response message comprises one of:
a first value acknowledging the first data part has been transmitted by a modem of the apparatus; and
a second value indicating the first data part was not transmitted and/or that the status of the transmission cannot be provided.

3. The apparatus as in claim 1, wherein controlling the flow of the data stream comprises:
causing a next data part of the data stream to be transmitted when the link layer response message acknowledges the transmission of the first data part of the application, and
causing the next data part of the data stream to be skipped when the link layer response message fails to acknowledge transmission of the first data part of the application.

4. The apparatus as in claim 1, wherein the at least one memory and computer program code are configured to, with the at least one processor, cause the apparatus to further perform:
estimating a transmission delay of the data stream based on a first time value associated with the link layer response message wherein the link layer response message indicates that the first data part has been transmitted, and a second time value associated with a further link layer response message wherein the further link layer response message indicates that a next part of the data stream has been transmitted.

5. The apparatus as in claim 4, wherein the at least one memory and computer program code are configured to, with the at least one processor, cause the apparatus to further perform:
adjusting a transmission rate of the data stream based at least on the estimated transmission delay.

6. The apparatus as in claim 1, wherein the received link layer response message is generated in response to determining by a second communication protocol of the apparatus a transmission opportunity for the first data part.

7. The apparatus as in claim 6, wherein the first communication protocol is a packet data convergence protocol, and wherein the second communication protocol is a radio link control protocol.

8. The apparatus as in claim 1, wherein the at least one link layer request message and the received link layer response message are not transmitted by a modem of the apparatus.

9. The apparatus as in claim 1, wherein the data stream comprises a video stream such that each of the plurality of data parts of the data stream comprises a video frame.

10. The apparatus as in claim 9, wherein the video stream is a real-time video stream.

11. The apparatus as in claim 9, wherein inserting the at least one link layer request message comprises:
inserting a first link layer request message prior to each video frame in the data stream and a second link layer request message after each video frame in the data stream.

12. (canceled)

13. A method comprising:
inserting at least one link layer request message into a data stream to be transmitted by an apparatus, wherein the data stream corresponds to an application and comprises a plurality of data parts, and wherein the at least one link layer request message requests a status of a transmission of a first data part of the plurality of data parts from a first communication protocol of the apparatus;
receiving a link layer response message indicative of the status of the transmission of the first data part from the first communication protocol; and
controlling a flow of the data stream based on the link layer response message, wherein the controlling of the flow of the data stream comprises selecting among 1) causing a next data part of the data stream to be transmitted or causing the next data part of the data stream to be skipped, and/or 2) adjusting a transmission rate of the data stream.

14. The method as in claim 13, wherein the link layer response message comprises one of:
a first value acknowledging the first data part has been transmitted by a modem of the apparatus; and
a second value indicating the first data part was not transmitted and/or that the status of the transmission cannot be provided.

15. The method as in claim 13, wherein controlling the flow of the data stream comprises:
causing a next data part of the data stream to be transmitted when the link layer response message acknowledges the transmission of the first data part of the application, and
causing the next data part of the data stream to be skipped when the link layer response message fails to acknowledge transmission of the first data part of the application.

16. The method as in claim 13, further comprising:
estimating a transmission delay of the data stream based on a first time value associated with the link layer response message wherein the link layer response message indicates that the first data part has been transmitted, and a second time value associated with a further link layer response message wherein the further link layer response message indicates that a next part of the data stream has been transmitted.

17. The method as in claim 16, further comprising:
adjusting a transmission rate of the data stream based at least on the estimated transmission delay.

18. The method as in claim 13, wherein the link layer response message to the at least one link layer request message is generated in response to determining by a second communication protocol of the apparatus a transmission opportunity for the first data part.

19. The method as in claim 18, wherein the first communication protocol is a packet data convergence protocol, and wherein the second communication protocol is a radio link control protocol.

20. The method as in claim 13, wherein the at least one link layer request message and the received link layer response message are not transmitted by a modem of the apparatus.

21-23. (canceled)

24. A non-transitory computer readable medium comprising program instructions for causing an apparatus to perform at least the following:
inserting at least one link layer request message into a data stream to be transmitted by an apparatus, wherein the data stream corresponds to an application and comprises a plurality of data parts, and wherein the at least one link layer request message requests a status of a transmission of a first data part of the plurality of data parts from a first communication protocol of the apparatus;
receiving a link layer response message indicative of the status of the transmission of the first data part from the first communication protocol; and
controlling a flow of the data stream based on the link layer response message, wherein the controlling of the flow of the data stream comprises selecting among 1) causing a next data part of the data stream to be transmitted or causing the next data part of the data stream to be skipped, and/or 2) adjusting a transmission rate of the data stream.

25-34. (canceled)
